(19) United States
(12) Patent Application Publication
(10) Pub. No.: US 2018/0211292 A1
(43) Pub. Date: Jul. 26, 2018

(54) TRACKING THE STATE OF BILLING RECORDS IN A METERED BILLING SYSTEM FOR RESOLVING BILLING DISPUTES

(71) Applicant: INTERNATIONAL BUSINESS MACHINES CORPORATION, Armonk, NY (US)

(72) Inventors: Shih-Chung Fang, Schaumburg, IL (US); Peter W. Gayek, Chapel Hill, NC (US); Michael Jen, Baldwin Place, NY (US); Bruce A. Merrill, Lansdale, PA (US); Deborah A. Ward, Austin, TX (US)

(21) Appl. No.: 15/414,946

(22) Filed: Jan. 25, 2017

(51) Int. Cl. G06Q 30/04

(52) U.S. Cl. CPC G06Q 30/04

(57) ABSTRACT

A computer-implemented method includes: receiving a resource unit (RU) record associated with a metered resource provided by a service provider to a client; tracking status of the RU record and updating the status based on receiving dispute resolution information regarding the RU record; adding the RU record to a final invoice when the status of the RU record indicates that the RU was not disputed or when the status of the RU record indicates that the RU was disputed and valid; deleting RU record from a billing dimension to prevent the RU record from being added to the final invoice when the status of the RU record indicates that the RU record was disputed and invalid; retaining the RU record in the billing dimension when the status of the RU record indicates that the RU record is disputed and unsettled; and providing the final invoice to a client billing system.

### BACKGROUND

The present invention generally relates to billing dispute management in a metered resource environment and, more particularly, to billing dispute management by tracking the state of billing records and resolving billing disputes before issuing a final invoice. Service providers may charge service consumers for resources that the provider managed or that the service consumer (client) used during a given service period. For example, a cloud-based IT service provider may charge an agreed price for each computer managed, for each call to a help desk, for computer hours used, etc. Services provided may be referred to as “resource units” or “RUs”. The service provider provides the client with charge summary reporting that contains the quantity and charge for each RU, and also with detail reporting that lists out all the individual computers or calls managed, with some identifying information about each. The charges are rolled into an invoice that usually summarizes the charges further (e.g., by groups of RUs, or broad service categories).

Charges in an invoice may be based on records that may sometimes be automatically entered based on metered usage. Automatic metered billing provides as a level of convenience and billing accuracy to the service provider. For example, when a call is made to a help desk by a client, a call tracking system may track the duration of the call and automatically provide a record to an invoicing system. The invoicing system may then automatically add a charge corresponding to the call record to the invoice. As another example, computer network usage and/or other computer resource usage may be tracked (e.g., metered) and charges may be automatically added to the invoice based on the metered usage.

Although metered billing is considered accurate in that the amount of resources are accurately tracked and billed accordingly, from time to time, the client may dispute charges at the level of specific resources consumed (computer resources used, help desk calls made, etc.). For example, the client may dispute that a charge relating to a call to a help desk when the call was precipitated by a problem caused by the service provider (e.g., based on servers no longer existing or being misclassified). As another example, a client may dispute a charge relating to processor resources consumed when a problem precipitated by the service provider caused an increase in the amount of resources consumed.

### SUMMARY

In an aspect of the invention, a computer-implemented method includes: receiving, by a computing device, a resource unit (RU) record associated with a metered resource provided by a service provider to a client; storing, by the computing device, the RU record; tracking, by the computing device, a status of the RU record and updating the status based on receiving dispute resolution information regarding the RU record; adding, by the computing device, the RU record to a final invoice when the status of the RU record indicates that the RU was not disputed or when the status of the RU record indicates that the RU was disputed and valid; deleting, by the computing device, the RU record from a billing dimension to prevent the RU record from being added to the final invoice when the status of the RU record indicates that the RU record was disputed and invalid; retaining, by the computing device, the RU record in the billing dimension when the status of the RU record indicates that the RU record is disputed and unsettled; and providing, by the computing device, the final invoice to a client billing system.

In an aspect of the invention, there is a computer program product for tracking disputes for metered resource units (RUs). The computer program product comprising a computer readable storage medium having program instructions embodied therewith, the program instructions executable by a computing device to cause the computing device to: track the status of a plurality of RU records stored in a provider's billing system, the plurality RU records each being associated with a metered resource provided by the provider to a client; analyze, at the end of a billing deadline, the plurality of RU records; determine a status of each of the plurality of RU records based on the analyzing; add a first subset of the plurality of RU records with an undisputed or settled valid status to a final invoice; remove a second subset of the plurality of RU records with settled invalid statuses from a billing dimension; maintain a third subset of the plurality of RU records having unsettled disputed statuses in the billing dimension; and provide the final invoice to a client billing system.

In an aspect of the invention, a system includes a CPU, a computer readable memory and a computer readable storage medium associated with a computing device; program instructions to receive a resource unit (RU) record associated with a metered resource provided by a service provider to a client; program instructions to store the RU record; program instructions to provide a preliminary invoice report identifying the RU record to a client; program instructions to receive an indication that the RU record is under dispute based on providing the preliminary invoice report; program instructions to store a status code within the RU record indicating that the RU record is under dispute; program instructions to prevent the RU record from appearing on a final invoice associated with a first billing period in which the preliminary invoice report was provided; program instructions to receive an indication, in a second billing period, that the RU record has been resolved and agreed to be paid by the client; program instructions to add the RU record to a final invoice associated with the second billing period based on receiving the indication that the RU record has been resolved. The program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows an overview of an example implementation in accordance with aspects of the present invention

FIG. 5 shows an example environment in accordance with aspects of the present invention.

FIG. 6 shows an example table identifying status markers/codes that may be added to an RU record to indicate the status of the RU in accordance with aspects of the present invention.

FIG. 7 shows an example RU record in accordance with aspects of the present invention.

FIG. 8 shows a block diagram of example components of a provider billing system and an RU record tracking component in accordance with aspects of the present invention.

FIGS. 9A and 9B show an example flowchart of a process for tracking the status of RU records and generating a final invoice with only RU records that are have been agreed to be billed in accordance with aspects of the present invention.

FIG. 10 shows an example flowchart of a process for tracking the status of RU records and generating a final invoice with only RUs that are have been agreed to be billed in accordance with aspects of the present invention.

FIG. 11 shows an example flowchart of a process for generating a final invoice based on tracking the status of RU records in accordance with aspects of the present invention.

FIG. 12 shows an example table defining the attributes and parameters associated to a lifecycle state transition in respect to billing and usage dimensions in accordance with aspects of the present invention.

FIG. 13 shows an example table summarizing RU record state transitions and associated scenarios in accordance with aspects of the present invention.

FIGS. 14A and 14B show example tables summarizing the categories that a client and provider may view organized as reporting elements and impacts within usage month boundaries in accordance with aspects of the present invention.

FIG. 15 shows an example table summarizing dispute management scenarios in accordance with aspects of the present invention.

FIGS. 16A and 16B show example tables summarizing items viewable by a client or provider a given report category selection in the billing dimension in accordance with aspects of the present invention.

FIG. 17 shows an example table summarizing items viewable by a client or provider a given report category selection in the usage dimension in accordance with aspects of the present invention.

FIG. 18 shows an example table summarizing counting formula(s) which can be applied in reports for the usage dimension in accordance with aspects of the present invention.

FIG. 19 shows an example table summarizing counting formula(s) which can be applied in the reports for the billing dimension in accordance with aspects of the present invention.

### DETAILED DESCRIPTION

The present invention generally relates to billing dispute management in a metered resource environment and, more particularly, to billing dispute management by tracking the state of billing records and resolving billing disputes before issuing a final invoice. Aspects of the present invention may provide an end-to-end dispute management work flow for tracking the invoicing status of a metered resource unit RU representing a unit of service which a cloud-based service provider has provided to a customer/client. Aspects of the present invention may provide a platform via which the service provider and the client can agree on RU details and charges before the service provider releases an invoice with a charge for the RU. Aspects of the present invention may be based around a finite state model that represents the lifecycle (e.g., the invoicing lifecycle) of metered RUs in both usage and time dimensions. In embodiments, detailed tracking and reporting on the state of every charge over time may be provided, and invoicing may be based on a periodic feed of information identifying charges for RU instances that are not in dispute. Advantageously, final invoices may include only those charges that have been finalized and agreed upon by both the provider and client, thereby reducing errors in invoicing and reducing mitigation efforts for correcting errors and disputes in an invoice.

As further described herein, aspects of the present invention may allow the client and the provider to better understand when a metered RU enters the invoicing process and when the RU had any impacts in relation to invoices. In addition, any metered RU may be associated with additional attributes representing how, when, and where the RU was delivered to/received by the client. This information can be used to correlate the metered RUs to real-world activities such as completed projects, resource migration, consolidation, and to the time/date the RU was measured/consumed. As such, both client and provider may more easily validate charges for an RU and associated invoice item(s) should a dispute arise.

As described herein, aspects of the present invention may include a system for tracking disputes for metered RUs. Each instance of an RU may can be disputed, held, and resolved over time in both usage and billing dimensions. Invoices that were already released can be adjusted in later billing periods based on late usage found and disputes resolved. Aspects of the present invention may include a finite state model that allows both current and late metered usage to be tracked. The state model may provide a technique for numerical formula(s) to be applied for roll-ups and calculations. As an illustrative, non-limiting example, a report may be generated to present the total currency value of all charges currently in dispute, by usage period (e.g., current and past periods). As described herein, transaction history may be tracked in both usage and billing dimensions which allows charge and volume trending analysis to be performed across both dimensions. For example, a report may be generated to present the history of specific charges (e.g., when an RU was reported, when the RU was disputed and why, and when the dispute was resolved). A variety of additional reports may be generated by tracking the invoicing/dispute status of an RU.

Aspects of the present invention may be applied in billing systems of a service provider and of the consumer, and may allow for internal chargeback within the consumer enterprise. In embodiments, time-based limits on when disputes and adjustments can be created by each party may be enforced (e.g., by automatically finalizing an invoice after a certain period of time in which the final invoice includes non-disputed RUs). In embodiments, automated billing qualification rules may be applied and exceptions may be reported. For example, qualifications rules may be applied to filter out certain transitions that should not be billed based on business rules. Qualified RUs may then be pre-invoiced at which time a client may have an opportunity to dispute the RU, and the state of the RU's dispute may be tracked.

As described herein, aspects of the present invention may track the lifecycle of RU records and may track that state of an RU record with respect to resolution of a dispute associated with the RU record. Further, aspects of the present invention relate to metered RU records in which consumed services are tracked by computers for services consumed in a computing environment. In particular, it is urged that the processes of the invention may not be practically performed by a human, as potentially thousands or more RU records may be tracked and managed in a relatively short period of time. Further, aspects of the present invention are rooted in computing technology to solve the technical problem of tracking a dispute for charges related to metered resources. The concept of tracking metered resources as described herein exists within computing technology itself, as metered resources may relate to the consumption of computer resources (e.g., cloud-based resources) such as computing usage, network usage, processor/computer storage usage, etc. which cannot be tracked by human processes. Additionally, it is noted that aspects of the present invention improve the functioning of computer billing systems by reducing the number of disputes raised after a final invoice has been provided, thereby reducing the amount of resources committed for settling such disputes and permitting computer resources to be used for other processes.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

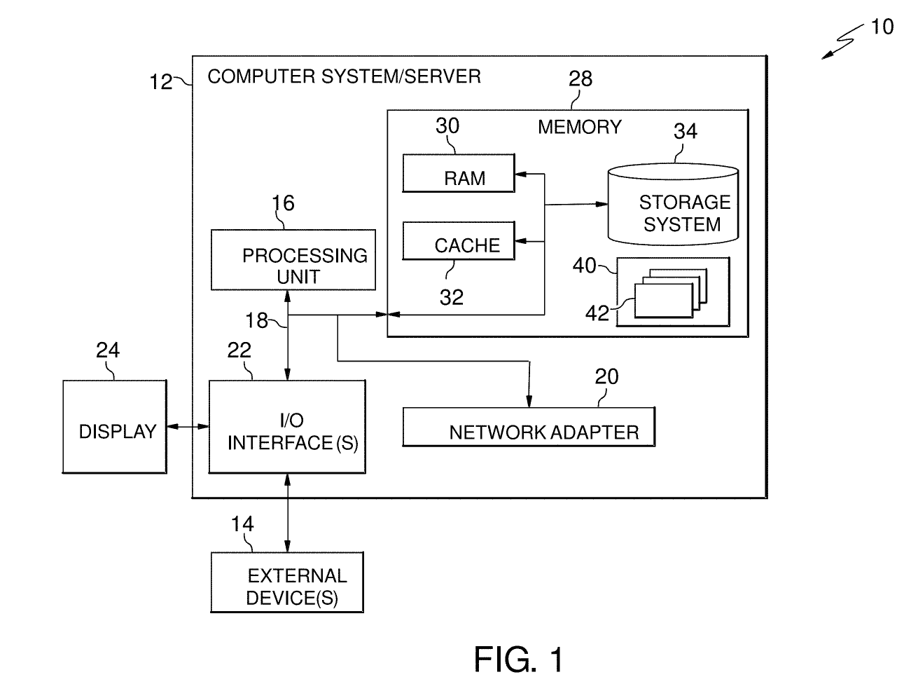

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

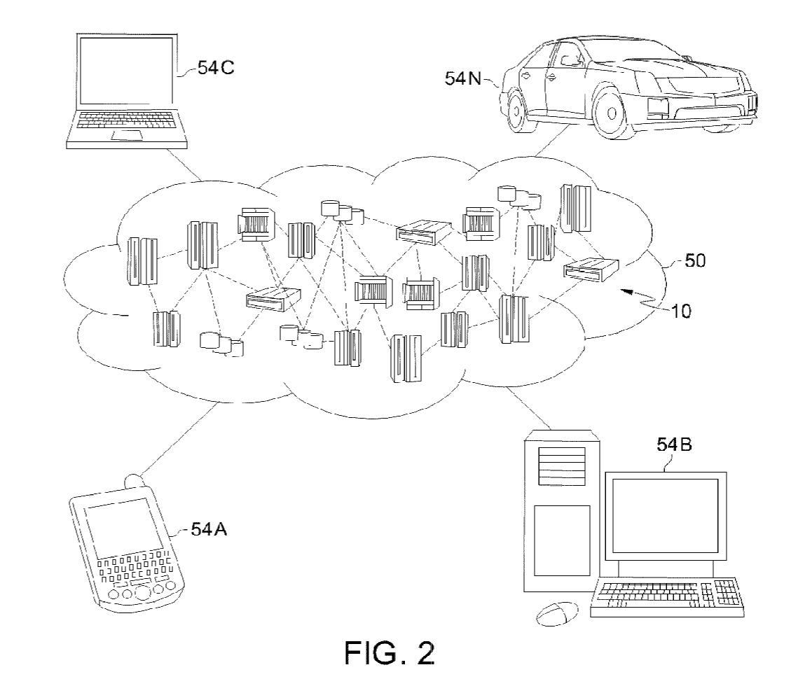

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

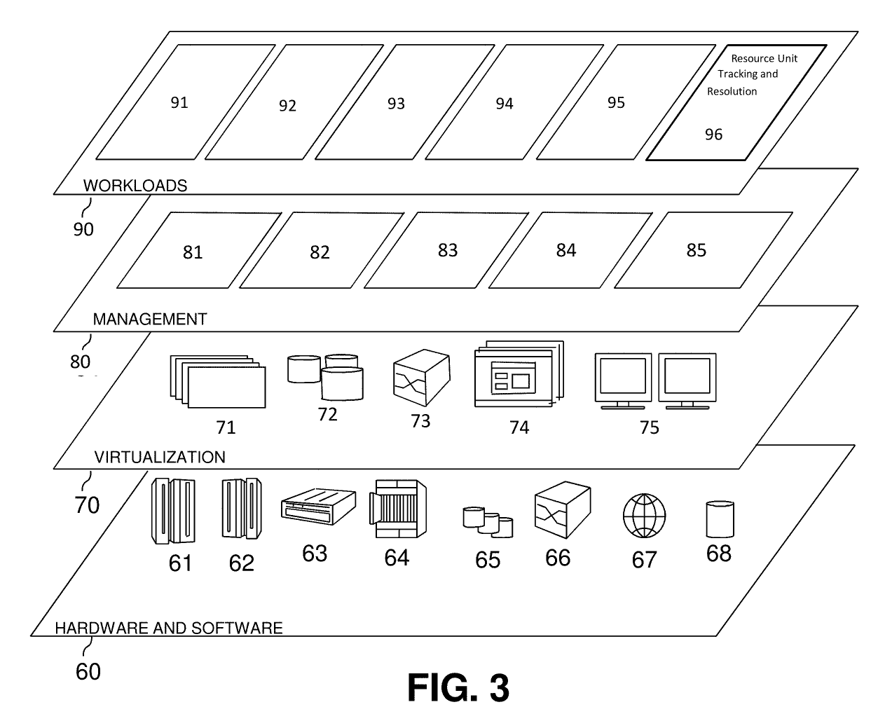

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and resource unit tracking and resolution 96.

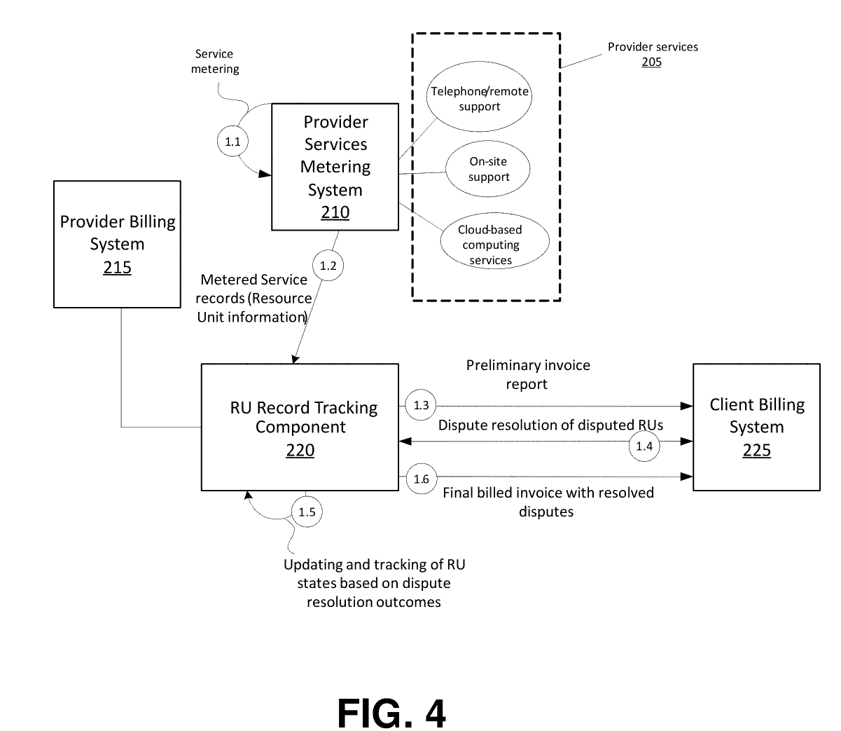

Referring back to FIG. 1, the program/utility 40 may include one or more program modules 42 that generally carry out the functions and/or methodologies of embodiments of the invention as described herein (e.g., such as the functionality provided by resource unit tracking and resolution 96). Specifically, the program modules 42 may provide a preliminary invoice report identifying details of a cloud-based RU delivered to a client, mark the RU as a disputed RU when disputed by the client, mark the RU as valid when a disputed RU is agreed to be paid by the client, and transfer the RU to a final invoice once marked as valid. The program modules 42 may further track RUs and automatically add non-disputed or validated RUs to a final billed invoice. Other functionalities of the program modules 42 are described further herein such that the program modules 42 are not limited to the functions described above. Moreover, it is noted that some of the modules 42 can be implemented within the infrastructure shown in FIGS. 1-3. For example, the modules 42 may be representative of a provider billing system 215 as shown in FIG. 4.

FIG. 4 shows an overview of an example implementation in accordance with aspects of the present invention. As shown in FIG. 4, a provider services metering system 210 may meter provider services 205 (step 1.1). For example, the provider services metering system 210 may track and meter provider services 205, such as telephone/remote support services, on-site support services, cloud-based computing services, etc. At step 1.2, a RU record tracking component 220 of a provider billing system 215 may receive meter service records including RU information and details (e.g., a quantity of services used, a rate per quantity, etc.). In embodiments, the RU record tracking component 220 may qualify certain metered service records by applying any number of business rules (e.g., by discarding service records for services that are not to be billed based on business rules, service level agreements, etc.). At step 1.3 the RU record tracking component 220 may provide a preliminary invoice report to a client billing system 225. The preliminary invoice report may identify qualified RUs only. At step 1.4, the RU record tracking component 220 and the client billing system 225 may communicate to resolve disputes for the RUs included in the preliminary invoice report. For example, an administrator of the client billing system 225 may review the preliminary invoice report and mark an RU as disputed. Other RUs may be marked as “agreed” or may not be marked at all and may be assumed to be agreed to be paid by the client. RUs that are marked as disputed may be resolved over a period of time, and at step 1.5, the RU statuses may be updated based on the outcomes of disputes. In this way, the RU record tracking component 220 may store and track information regarding the state of RU's. For example, the RU record tracking component 220 may store status codes representing the status of an RU as “undisputed,” “disputed,” “disputed and validated,” and “disputed and dropped.” The transaction history/path of an RU and its dispute may also be tracked for later analysis and reporting. The status codes may be used to instruct the RU record tracking component 220 on how to treat an RU. For example, at the end of a billing period, RUs whose status is “undisputed” and “disputed and validated” will be added to a final billed invoice and provided to the RU record tracking component 220 (e.g., as shown at step 1.6). RUs whose status is “disputed” will be held for billing and maintained for later re-evaluation by an administrator of the client billing system 225. RUs whose status is “disputed and dropped” will be marked as such in order to prevent these RUs from being billed (but may be continued to be stored by the RU record tracking component 220 for later reporting/analysis). In this way, only those RUs that are undisputed or disputed and validated may be billed, thereby reducing the chances for issuing invoices with invalid charges.

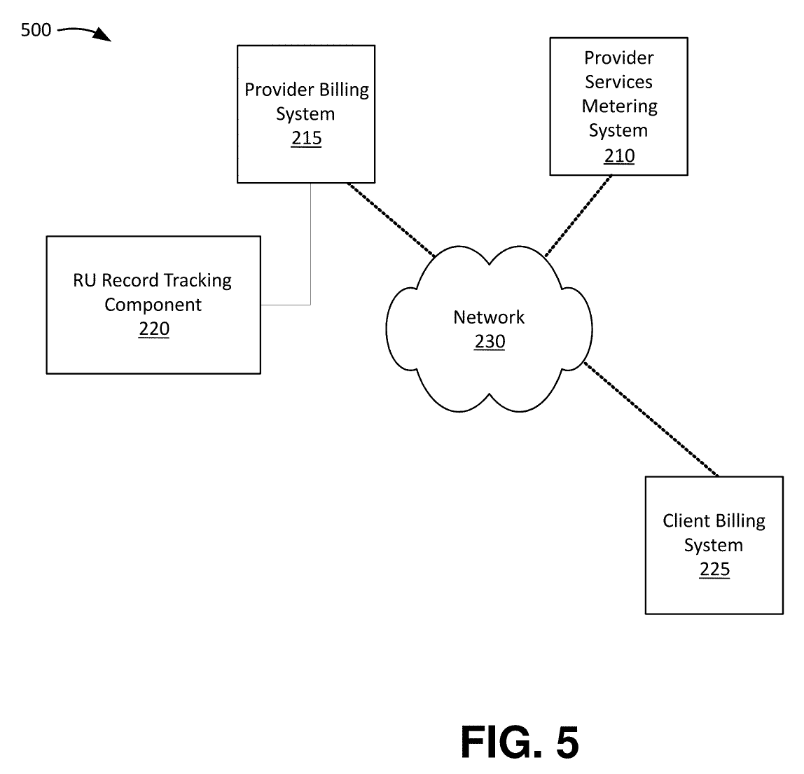

FIG. 5 shows an example environment in accordance with aspects of the present invention. As shown in FIG. 5, environment 500 may include a provider services metering system 210, a provider billing system 215, a client billing system 225, and network 230. In embodiments, one or more components in environment 500 may correspond to one or more components in the cloud computing environment of FIG. 2. In embodiments, one or more components in environment 500 may include components of computer system/server 12 of FIG. 1.

The provider services metering system 210 may include one or more computing devices (e.g., such as computer system/server 12 of FIG. 1) that tracks and meters services provided by a service provider. For example, the provider services metering system 210 may track a number of minutes for a telephone support call for a client, an amount of cloud computing resources provided to the client, on-site support provided to the client, and/or other types of meterable resources provided to the client.

The provider billing system 215 may include one or more computing devices (e.g., such as computer system/server 12 of FIG. 1) that manages billing/invoicing processes for a provider. In embodiments, the provider billing system 215 may provide final billed invoices to the client billing system 225 for payment of services rendered (e.g., cloud-based metered services). The provider billing system 215 may include the RU record tracking component 220 which may correspond to a module 42 of FIG. 1. In embodiments, the RU record tracking component 220 may qualify metered RUs for charging, generate a preliminary invoice with qualified RUs, and track the status of RUs in the billing/dispute lifecycle. For example, the RU record tracking component 220 may mark an RU with codes indicating how to treat the RU at the end of a billing cycle. As described herein, the provider billing system 215 may bill the RU when it is undisputed or disputed and later validated, hold the RU until a subsequent billing cycle when the RU is under dispute, or discard the RU from a billing domain when the RU is disputed and later dropped. As described herein, the RU record tracking component 220 may prepare reports that are based on tracking the status of RUs. For example, the RU record tracking component 220 may prepare reports indicating the historical transition and/or dispute history of RUs between various states in the dispute and billing lifecycle. The RU record tracking component 220 may prepare reports indicating the conditions under which a dispute was made so that qualification rules may be updated to filter our future RUs meeting those conditions and prevent those RUs from being included in a preliminary invoice.

The client billing system 225 may include one or more computing devices (e.g., such as computer system/server 12 of FIG. 1) that receives preliminary and final invoices from the provider billing system 215. The client billing system 225 may provide a user interface via which a client may dispute an RU and communicate with the dispute with the RU record tracking component 220. The client billing system 225 may track RUs on the client side so that the client can remain apprised of the status of an RU and its dispute resolution.

The network 230 may include network nodes, such as network nodes 10 of FIG. 2. Additionally, or alternatively, the network 230 may include one or more wired and/or wireless networks. For example, the network 230 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 230 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 500 is not limited to what is shown in FIG. 5. In practice, the environment 500 may include additional devices and/or networks; fewer devices and/or networks; different devices and/or networks; or differently arranged devices and/or networks than illustrated in FIG. 5. Also, in some implementations, one or more of the devices of the environment 500 may perform one or more functions described as being performed by another one or more of the devices of the environment 500. Devices of the environment 500 may interconnect via wired connections, wireless connections, or a combination of wired and wireless connections.

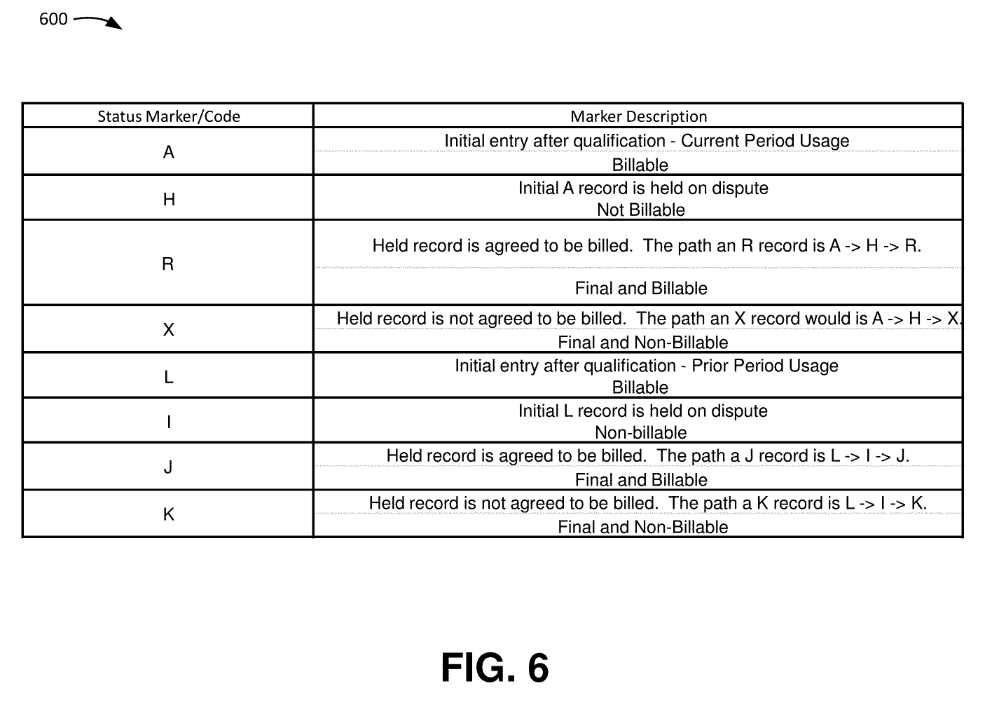

FIG. 6 shows an example table 600 identifying status markers/codes that may be added to an RU record to indicate the status of the RU. As described herein, the RU record tracking component 220 may and/or modify status codes in stored within an RU record (e.g., corresponding to step 1.5 of FIG. 4). As shown in FIG. 6, a code of “A” indicates an initial entry of an RU record into provider billing system 215 during a current usage period (e.g., after the RU has been qualified to be billed). RU records with the “A” status are considered billable (e.g., RU records with the “A” status may be added to a final invoice at the end of a billing period). A code of “H” indicates that an RU record (that was initially an “A” record) is in a hold status (e.g., when the RU record is in dispute). RU records with the “H” status are not billable and may not be added to a final invoice, but may be retained in a billing domain for possible subsequent billing as described below.

As further shown in FIG. 6, a code of “R” indicates that an RU record was previously a held record and has been agreed to be billed. The path of an RU record with the “R” code is “A” to “H” to “R”. RU records with the “R” status are billable and may be added to a final invoice. A code of “X” indicates that an RU record was previously a held record and has not been agreed to be billed (and should thus be dropped). The path of an RU record with the “X” code would be A to H to X. RU records with the “X” status may not be billed and may not be retained in the billing domain for possible billing in a subsequent billing period.

As further shown in FIG. 6, a code of “L” indicates an initial entry of an RU record into the provider billing system 215 during a prior usage period. For example, an RU record may be entered into the provider billing system 215 late for a variety of extending reasons (e.g., late reporting by the provider services metering system 210, etc.). The codes “I”, “J,” and “K,” are similar to those of “H”, “R”, and “X”, but with the difference being that “I”, “J,” and “K,” initially begin with an “L” status. The status codes shown in FIG. 6 are for illustrative proposes only and in practice, the status codes may differ from what is shown in FIG. 6.

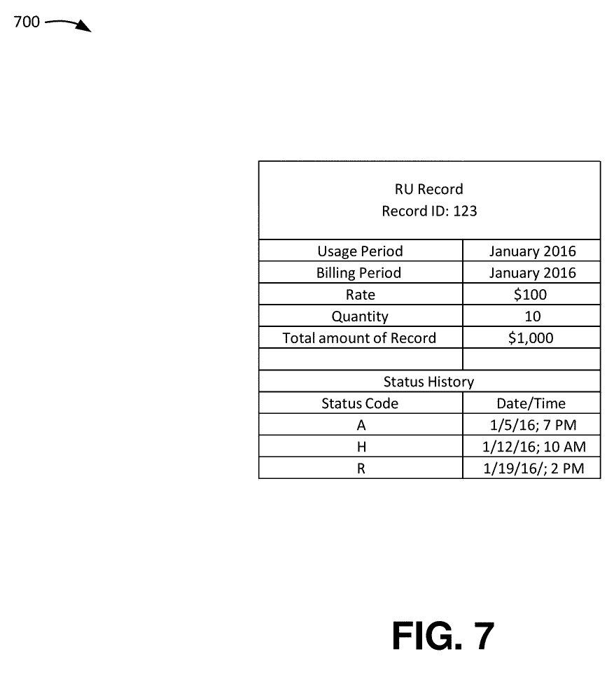

FIG. 7 shows an example RU record 700 in accordance with aspects of the present invention. As shown in FIG. 7, RU record 700 may include a variety of details regarding the RU, such as an ID, a usage period, a billing period, a rate, a quantity, and a total charge amount. The RU record 700 may include other information not shown in FIG. 7, such as comments regarding the RU, project ID associated with the RU, service request number, order number, etc. As further shown in FIG. 7, the RU record 700 may identify a status history of the RU. In the illustrative example shown, the RU record 700 may identify that the RU was marked with the “A” code on 1/5/16 at 7 PM, the “H” code on 1/12/16 at 10 AM, and the “R” code on 1/19/16 at 2 PM. Individual RU records 700 may be generated, maintained, and stored for each metered record of service received by the provider billing system 215 from the provider services metering system 210. As described herein, the individual RU records 700 may be generated, maintained, and stored by the RU record tracking component 220.

Information in the RU records 700 may be used to determine how to handle each RU at the end of a billing cycle (e.g., by adding charges for the RU to a final invoice when the current status is “A,” “R,” “L”, or “J,” hold the RU for possible charging in a subsequent billing cycle when the status is “H,” or “I”, or drop the RU altogether from a billing domain when the status is “X” or “K”. Also, the other reports may be generated based on the RU records 700. For example, reports may be generated to identify the number of disputes made in a billing cycle, the number/proportion of disputes agreed to be paid, the number/proportion of disputes dropped, a percentage of RUs disputed by RU attributes (e.g., percentage of RUs disputed based on type of service, department associated with the service, etc.).

Electronic invoices may also be generated based on the RU records 700 as well as reports that enable the client and the provider to verify and tie-out all billable charges from the summary charges to each detailed line item. Disputes may be filtered and presented in a separate report in relation to either the usage or billing dimension. The client or provider may raise a dispute thereby changing the lifecycle status of a given RU, which will be reflected in the status history of a corresponding RU record 700. Once the dispute has been resolved, the RU can be included in the next invoice cycle. It should be noted that depending on the implementation of this invention, disputes can be automatically transitioned to a different lifecycle state dependent on contract parameters. In this scenario held or disputed usage data can be verified and included automatically in a future invoice without human intervention. This verification as an example can be done automatically by correlating the RU attributes such as service request number, with completed service requests.

As described herein, RU records 700 may be accessed by both the provider billing system 215 and the client billing system 225. In this way, both the provider and the client may access a complete audit trail of the RU from when the RU was first introduced to the provider billing system 215 to when the RU was qualified for inclusion in an invoice and potentially to when the RU is first disputed as a charge and ultimately to the RU's final resolution when the dispute is settled and the final invoice to which the charges will be associated. During this entire lifecycle, the client will have a full view of all the state changes of the RU, along with the associated attributes. An RU record 700 may also identify the material quantity and associated impact in both the usage and billing dimensions.

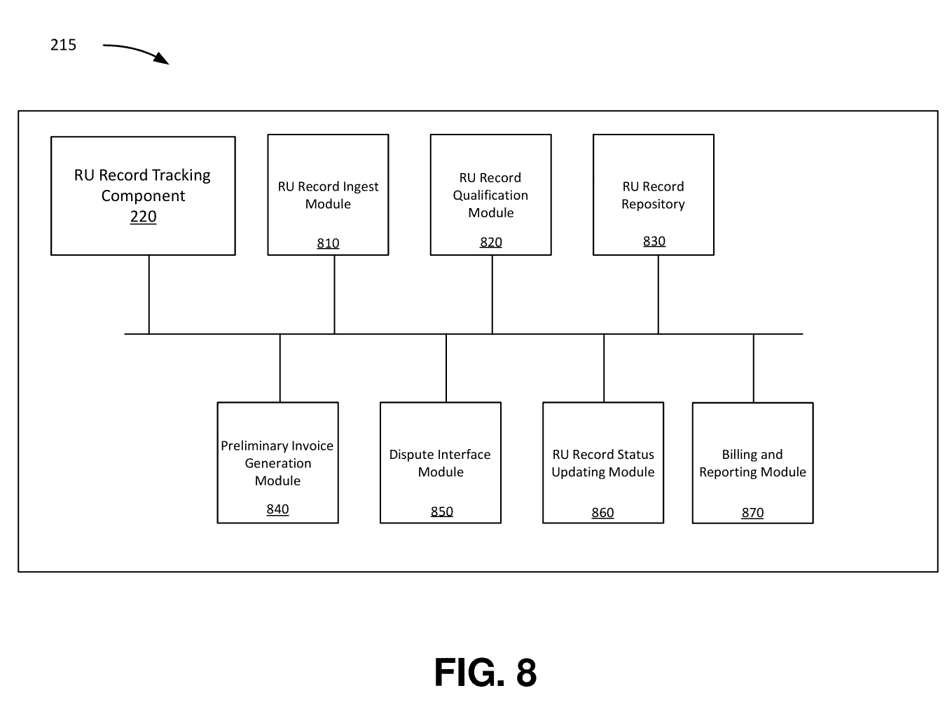

FIG. 8 shows a block diagram of example components of a provider billing system and an RU record tracking component in accordance with aspects of the present invention. As shown in FIG. 8, the provider billing system 215 may include the RU record tracking component 220, a RU record ingest module 810, a RU record qualification module 820, a RU record repository 830, a preliminary invoice generation module 840, a dispute interface module 850, an RU record status updating module 860, and a billing and reporting module 870. In embodiments, the provider billing system 215 may include additional or fewer components than those shown in FIG. 8. In embodiments, separate components may be integrated into a single computing component or module. Additionally, or alternatively, a single component may be implemented as multiple computing components or modules. In embodiments, the and the RU record tracking component 220 may perform one or more of the functions as the RU record ingest module 810, RU record qualification module 820, RU record repository 830, preliminary invoice generation module 840, dispute interface module 850, RU record status updating module 860, and/or billing and reporting module 870.

The RU record ingest module 810 may include a program module (e.g., program module 42 of FIG. 1) that receives and processes RU records (e.g., metered service records) from the provider services metering system 210. For example, the provider services metering system 210 may provide RU records identifying metered RU services that are being consumed by a client. In embodiments, the RU record ingest module 810 may receive RU records in real-time and/or at recurring or periodic intervals. As described herein, an RU record may identify a type of service, a quantity/unit of the service consumed, a rate, a system via which the quantity of service consumed was measured, an amount (e.g., quantity multiplied by rate), a dimension in time (e.g., usage time, a billing period, comments regarding the record, attributes regarding the record (e.g., project ID, service request number, order number, etc.), an audit record of usage, and placeholders for invoice lifecycle state (e.g., for which status codes may later be stored).

The RU record qualification module 820 may include a program module (e.g., program module 42 of FIG. 1) that may qualify RU records for being billed to the client. For example, the RU record qualification module 820 may qualify RU records by applying any number of business rules (e.g., by discarding RU records from a billing dimension for services that are not to be billed based on business rules, service level agreements, etc.). As an example, the RU record qualification module 820 may not qualify (e.g., discard RU records from the billing dimension) for a certain type or quantity of services that are not to be billed in accordance with a service level agreement (e.g., the first X units of a particular service per billing cycle may be free).

The RU record repository 830 may include a data storage device (e.g., storage system 34 of FIG. 1) that stores qualified RU records once qualified by the RU record qualification module 820. In embodiments, information stored by the RU record repository 830 may be accessible by both the client and the provider (e.g., the provider may provide access to the qualified RU records).

The preliminary invoice generation module 840 may include a program module (e.g., program module 42 of FIG. 1) that may generate a preliminary invoice based on the qualified RUs stored in the RU record repository 830. In embodiments, the preliminary invoice may identify the RUs to be charged in a final invoice. The preliminary invoice may identify the RUs as well as the details of the RU (usage period, billing period, quantity, rate, amount, etc.). The preliminary invoice generation module 840 may provide the preliminary invoice to the client billing system 225 in order for the client to review the preliminary invoice and have the opportunity to dispute one or more of the RUs.

The dispute interface module 850 may include a program module (e.g., program module 42 of FIG. 1) that may receive information regarding disputes for RUs identified in a preliminary invoice. The dispute interface module 850 may provide a portal and/or user interface to the RU record tracking component 220 via which a client may select to dispute one or more RUs. Further, the dispute interface module 850 may provide a portal and/or user interface to the RU record tracking component 220 via which the client may select to resolve a dispute. For example, the client may mark a disputed RU as “valid” in which the disputed RU is later agreed to be paid by the client or “invalid” in which the disputed RU is agreed to be dropped and not charged to the client (e.g., based on negation or discussion between the client and provider). An operator of the provider billing system 215 may also provide input regarding whether a disputed RU is valid or invalid.

The RU record status updating module 860 may include a program module (e.g., program module 42 of FIG. 1) that may manage and update the status of RU records. For example, when an RU is initially stored in the RU record repository 830, the RU record status updating module 860 may mark the RU with a status of “A” (e.g., when a usage period of the RU is the same as a current billing period) or “L” (e.g., when a usage period of the RU is different than that of the current billing period). When an RU is disputed (e.g., by a client via the dispute interface module 850), the RU record status updating module 860 may update the RU status to “H” or “I” (e.g., depending on whether the RU was initially marked as “A” or “L”). When a disputed RU (e.g., an RU that has a status of “H” or “I”) is later marked as valid via the dispute interface module 850, the RU record status updating module 860 may update the status of the RU to “R” or “J” (e.g., depending on whether the RU was previously marked as “H” or “I”). When a disputed RU (e.g., an RU that has a status of “H” or “I”) is later marked as valid via the dispute interface module 850, the RU record status updating module 860 may update the status of the RU to “X” or “K” (e.g., depending on whether the RU was previously marked as “H” or “I”).

The billing and reporting module 870 may include a program module (e.g., program module 42 of FIG. 1) that may generate a final billing invoice at the end of a billing cycle or other billing deadline. The billing and reporting module 870 may generate the final bill based on the status codes of the RUs. For example, the billing and reporting module 870 may add RUs with a code of “A”, “R”, “L”, or “J” to the final bill. The billing and reporting module 870 may also maintain RUs with a status of “H” or “I” in a billing dimension or billing repository until those RUs are later updated to a status of “R”, “X”, “J”, or “K”. The billing and reporting module 870 may discard RUs with a code of “X” or “K” from the billing dimension such that those RUs are not billed. In this way, a final bill will only include those bills that were never disputed or were disputed and were later to have been agreed to be paid by the client.

As described herein, the billing and reporting module 870 may also generate reports based on RUs and their details/status. For example, the billing and reporting module 870 may generate a report that presents the history of specific charges (e.g., when an RU was reported, when the RU was disputed and why, and when the dispute was resolved). Additionally, or alternatively, the billing and reporting module 870 may prepare reports indicating the historical transition and/or dispute history of RUs between various states in the dispute and billing lifecycle. The billing and reporting module 870 may prepare reports indicating the conditions under which a dispute was made so that qualification rules may be updated to filter our future RUs meeting those conditions and prevent those RUs from being included in a preliminary invoice.

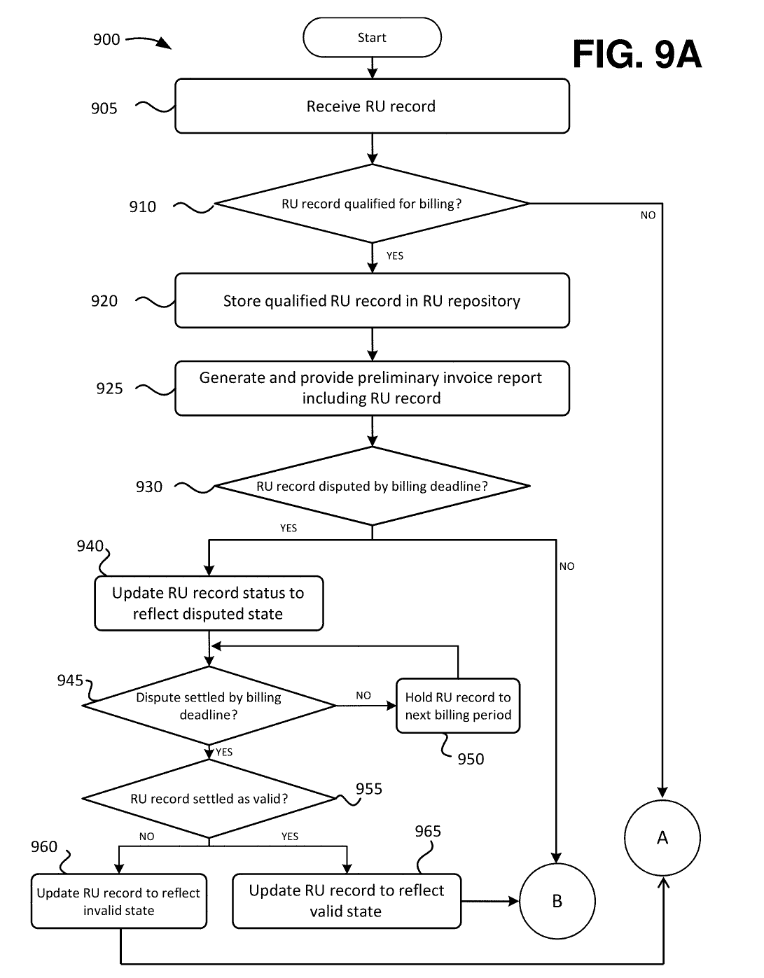

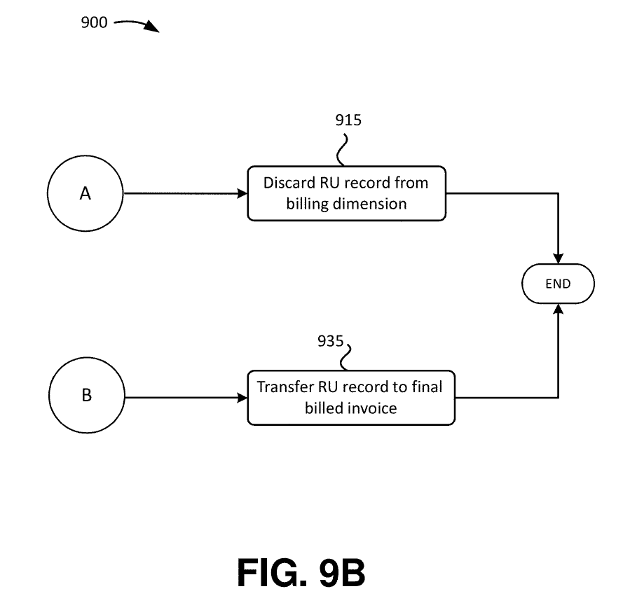

FIGS. 9A and 9B show an example flowchart of a process for tracking the status of RU records and generating a final invoice with only RU records that are have been agreed to be billed. The steps of FIGS. 9A and 9B may be implemented in the environment of FIG. 5, for example, and are described using reference numbers of elements depicted in FIG. 5. As noted above, the flowchart illustrates the architecture, functionality, and operation of possible implementations of systems, methods, and computer program products according to various embodiments of the present invention.

As shown in FIG. 9A, process 900 may include receiving an RU record (step 905). For example, as described above with respect to the RU record ingest module 810, the provider billing system 215 may receive, from the provider services metering system 210, the RU record identifying a metered RU service consumed by a client.

Process 900 may further include determining whether the RU record is qualified for billing (step 910). For example, as described above with respect to the RU record ingest module 810, the RU record tracking component 220 may qualify the RU record by applying any number of business rules, rules/terms from service level agreements, etc.). As an example, the RU record qualification module 820 may not qualify the RU for a certain type or quantity of services that are not to be billed in accordance with a service level agreement (e.g., the first X units of a particular service per billing cycle may be free).

If, for example, the RU record is not qualified, process 900 may proceed to point A as shown in FIG. 9B. For example, process 900 may include discarding the RU record from the billing dimension (step 915). For example, the RU record tracking component 220 may discard the RU such that the RU is not billed. Non-qualified RUs may still be retained for future reporting/analysis. Subsequent to discarding the RU record from the billing dimension, process 900 may end.

If, on the other hand, the RU is qualified, referring back to FIG. 9A, process 900 may include storing the RU record in an RU repository (step 920). For example, the RU record tracking component 220 may store the RU record in the RU record repository 830. In embodiments, the RU record tracking component 220 may also mark the RU with a status code of “A” or “L” (depending on whether the usage period matches a current billing period).

Process 900 may also include generating a providing a preliminary invoice report including the RU record (step 925). For example, as described above with respect to the RU record ingest module 810, the RU record tracking component 220 may generate a preliminary invoice identifying the qualified RU stored in the RU record repository 830. In embodiments, the preliminary invoice may identify the RU to be charged in a final invoice. The preliminary invoice may identify the RU as well as the details of the RU (usage period, billing period, quantity, rate, amount, etc.). The RU record tracking component 220 may provide the preliminary invoice to the client billing system 225 in order for the client to review the preliminary invoice and have the opportunity to dispute the RU.

Process 900 may also include determining whether the RU record has been disputed by a billing deadline (step 930). For example, as described above with respect to the dispute interface module 850, the RU record tracking component 220 may receive an indication that the client has disputed the RU record. Alternatively, the RU record tracking component 220 may not receive an indication that the client has disputed the RU record (e.g., if the client agrees that the RU record and associated charges are valid and acceptable). If, for example, the RU record has not been disputed by a billing deadline (step 930-NO), process 900 may proceed to point B. For example, referring to FIG. 9B, process 900 may include transferring the RU record to a final billed invoice (step 935). In this way, the final billed invoice may include the RU record when it has not been disputed by the billing deadline, and thus, a limited amount of time may be implemented for the client to dispute the RU record. Once all RU records for a billing period have been added to the final billed invoice, the final billed invoice may be provide to the client billing system 225. Subsequent to step 935, process 900 may end.

Referring back to FIG. 9A, if the RU record has been disputed by the billing deadline (step 930-YES), process 900 may further include updating the RU record status to reflect the disputed state (step 940). For example, the RU record tracking component 220 may update the status of the RU record to the “H” or “I” state and may also store a timestamp indicating a time when the status of the RU record changed.

Process 900 may also include determining whether the dispute has been settled by the billing deadline (step 945). For example, as described above with respect to the dispute interface module 850, the RU record tracking component 220 may receive an indication as to whether the dispute has been settled (e.g., based on communications between the client and the provider). If, for example, the dispute has not been settled (step 945-NO), process 900 may include holding the RU record to the next billing period (step 950). Process 900 may return to step 945 at which point a determination is made as to whether the dispute has been settled. In this way, the RU record is held for billing (e.g., not billed, but not discarded from the billing dimension) until the disputed has been settled.

If, on the other hand, the dispute has been settled (step 945-YES), process 900 may include determining whether the RU record was settled as valid (step 955). For example, as described above with respect to the dispute interface module 850, the RU record tracking component 220 may receive an indication as to whether the dispute has been settled as valid or invalid (e.g., depending on the results of a dispute process between the client and the provider). If, for example, the dispute has been settled as invalid (step 955-NO), process 900 may include updating the RU record to reflect an invalid state (step 960). For example, as described above with respect to the RU record status updating module 860, the RU record tracking component 220 may update the RU record to reflect that the RU record has been settled as invalid. As an example, the RU record tracking component 220 may update the status code to “X” or “K” and may add a timestamp indicating a time of the status change. Process 900 may proceed to point A which at which point the RU record is removed from the billing domain and is not included in a final invoice.

If, on the other hand, the dispute has been settled as valid (step 955-YES), process 900 may include updating the RU record to reflect the valid state (step 965). For example, as described above with respect to the RU record status updating module 860, the RU record tracking component 220 may update the RU record to reflect that the RU record has been settled as valid. As an example, the RU record tracking component 220 may update the status code to “R” or “J” and may add a timestamp indicating a time of the status change. Process 900 may proceed to point B at which point the RU record is added to the final invoice.

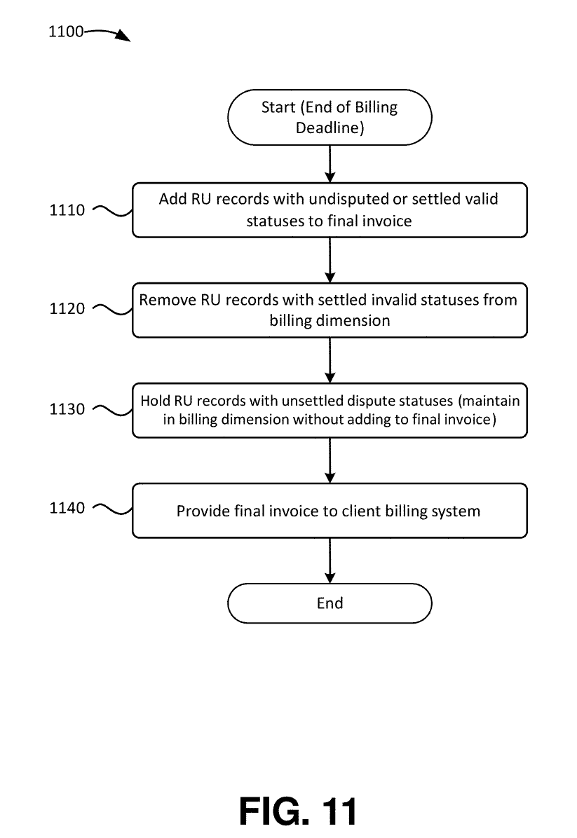

As shown in FIGS. 9A, and 9B, process 900 may be performed to track the status of an RU record throughout its lifecycle from the time the RU record is received and generated from the time it is added to a final invoice, or removed from the billing dimension (e.g., based on the results on a dispute process). As described in greater detail with respect to FIG. 11, the RU record tracking component 220 may analyze RU records at the end of the billing cycle to determine which RU records are to be removed from the billing domain, added to a final invoice, or held for re-analysis in a subsequent billing cycle. As described herein, a variety of reports may be generate based on the tracking the status of RU records.

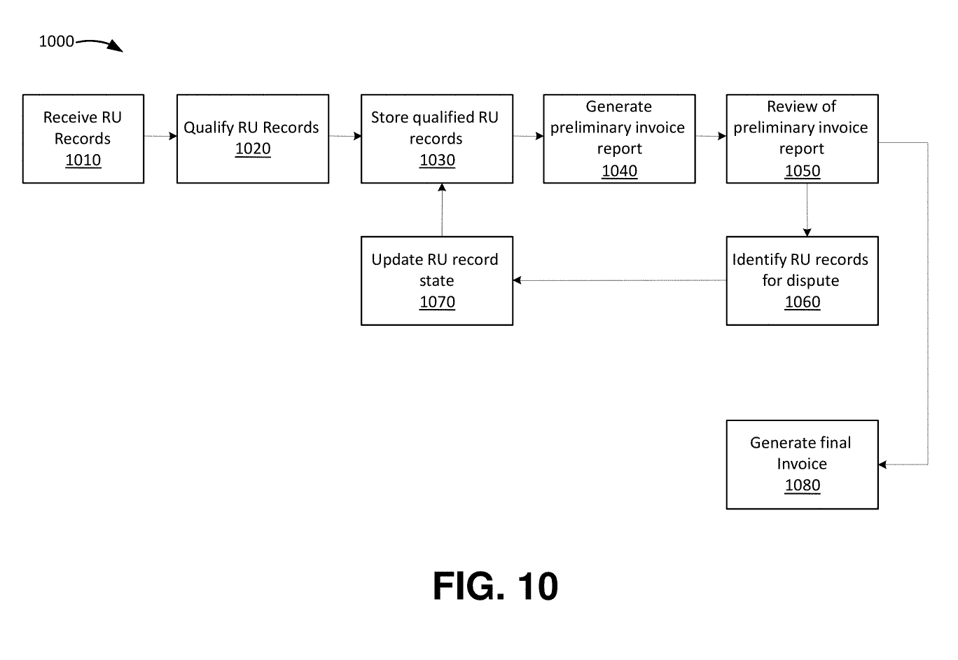

FIG. 10 shows an example flowchart of a process for tracking the status of RU records and generating a final invoice with only RUs that are have been agreed to be billed. The steps of FIG. 10 may be implemented in the environment of FIG. 5, for example, and are described using reference numbers of elements depicted in FIG. 5. As noted above, the flowchart illustrates the architecture, functionality, and operation of possible implementations of systems, methods, and computer program products according to various embodiments of the present invention. The process of FIG. 10 may correspond to a variation of the process of FIGS. 9A and 9B and may apply for multiple RU records.

As shown in FIG. 10, process 1000 may include receiving RU records (step 1010). For example, the RU record tracking component 220 may receive RU records in a similar manner as discussed above with respect to step 905 of FIG. 9A. Process 1000 may further include qualified the RU records (step 1020). For example, the RU record tracking component 220 may qualify the RU records in a similar manner as discussed above with respect to step 910 of FIG. 9A.

Process 1000 may also include storing qualified RU records (step 1030). For example, the RU record tracking component 220 may store the qualified RU records in a similar manner as discussed above with respect to step 920. Process 1000 may further include generating a preliminary invoice report (step 1040). For example, the RU record tracking component 220 may generate the preliminary invoice report in a similar manner as described above with respect to step 920 of FIG. 9A. The preliminary invoice report may be provided to the client billing system 225.

Process 1000 may also include reviewing of the preliminary invoice report (step 1050). For example, a client may review the preliminary invoice report received via the client billing system 225. Process 1000 may further include identifying RU records for dispute (step 1060). For example, the client may identify RU records for which the client believes to be invalid. In embodiments, the client may provide an indication to dispute one or more of the RU records via the dispute interface module 850.

Process 1000 may further include updating the RU record state (step 1070). For example, the RU record tracking component 220 may update the RU record state of disputed invoices in the stored RU records repository (as shown by a connection between steps 1070 and 1030). Process 1000 may repeat steps 1040 and 1050 in which an updated preliminary invoice may be provided identifying the disputed RUs. From step 1050, process 1000 may proceed to step 1080 in which a final invoice is generated identifying the RUs having a status indicating that the RU was never disputed or that the RU was disputed and later agreed to be paid by the client (e.g., settled as valid).

FIG. 11 shows an example flowchart of a process for generating a final invoice based on tracking the status of RU records. The steps of FIG. 11 may be implemented in the environment of FIG. 5, for example, and are described using reference numbers of elements depicted in FIG. 5. As noted above, the flowchart illustrates the architecture, functionality, and operation of possible implementations of systems, methods, and computer program products according to various embodiments of the present invention.

As shown in FIG. 11, process 1100 may start when a billing deadline ends (e.g., on a date and time corresponding to a billing deadline). Process 1100 may include adding RU records with undisputed or settled valid status to the final invoice (step 1110). For example, the RU record tracking component 220 may analyze the transaction history of the RU records currently stored in the billing dimension to determine the current status of the RU records. For those RU records that currently have an undisputed or settled valid status code (e.g., when the latest status code identifies an undisputed or settled valid status), the RU record tracking component 220 may add those RUs to the final invoice.

Process 1100 may further include removing RU records with settled invalid status from the billing dimension (step 1120). For example, the RU record tracking component 220 may remove the RU records that currently have a settled invalid status code. Process 1100 may also include holding RU records with unsettled dispute statuses (step 1130). For example, the RU record tracking component 220 may maintain the RU records with current status codes indicating a disputed and unsettled status in the billing dimension without adding those RU records to the final invoice (e.g., so that the these RU records are retained until they have been settled through a dispute process). Process 1100 may further include providing the final invoice to the client billing system 225 (step 1140). For example, the RU record tracking component 220 may provide the final invoice to the client billing system 225 such that the final invoice only includes those items that were never disputed or were disputed and agreed to be paid.

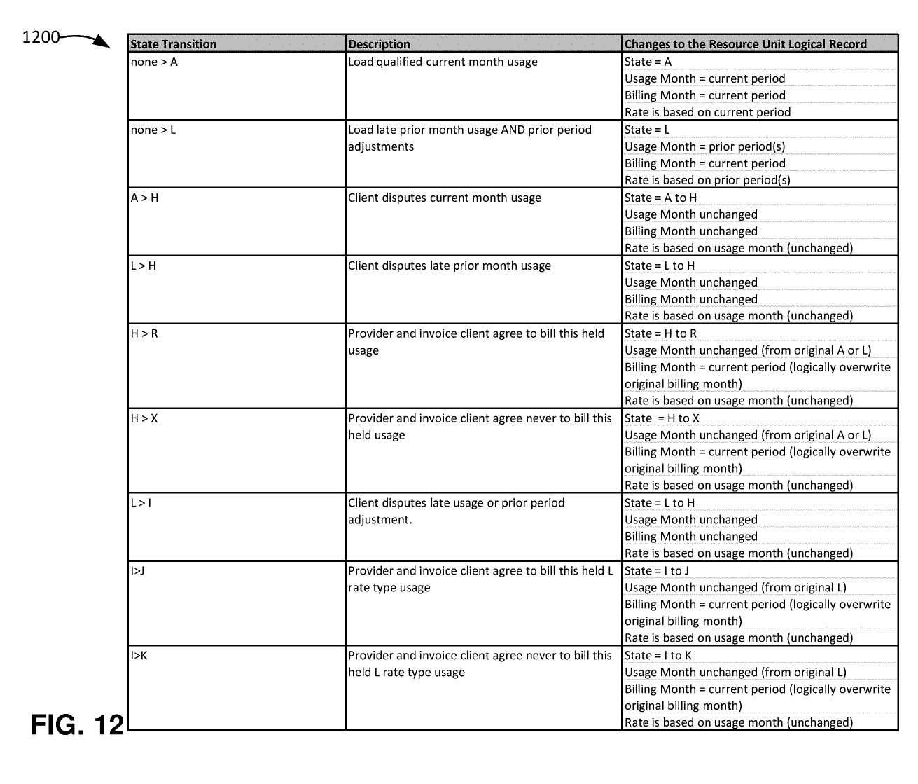

FIG. 12 shows a table 1200 that represents the various state transitions and their relation to usage and billing periods in accordance with aspects of the present invention. As shown in FIG. 12, table 1200 may summarize the lifecycle of an RU record, and further identifies transitions between different states and status codes of an RU record (e.g., from no status to the “A” status code, from the “A” status code to the “H” status code, etc.). Table 1200 further identifies a description of scenarios associated with each transition, and changes to the RU record that are made based on the transitions from one state to another (e.g., changes that the RU record status updating module 860 of FIG. 8 may make to an RU record, such as the RU record 700 shown in FIG. 7).

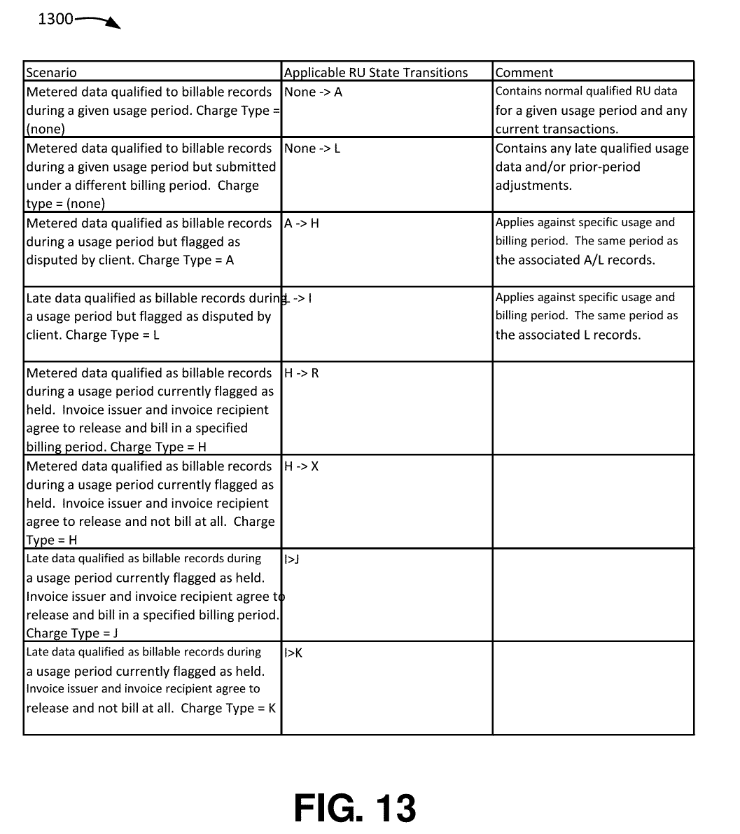

FIG. 13 shows a table 1300 that summarizes state transitions into billing scenarios as applicable between a client and provider. In an embodiment, all possible dispute scenarios in a dispute management system may be represented by the two finite state models in which each RU may have one possible state at a given point in time (e.g., in both the usage and the time dimensions). Furthermore, each RU may start its lifecycle in either associated to either the A or the L finite state model. When a dispute is raised the RU state is updated accordingly (e.g., by the RU record status updating module 860 of FIG. 8). Table 1300 summarizes how certain scenarios may correspond to the transition from one status code to the next. Further, as shown by table 1300 only certain precursor states may allow a transition to a dispute state. For example, once an RU record has moved into a resolved state (R, X, J or K) the RU record can no longer move into a disputed state. By having each state being mutually exclusive and each state having a defined branch, it is possible to model all possible states in the dispute management system.

As described above, when a dispute is created the date/time dimension of the dispute is recorded along with attributes of the dispute, such as the reason for the dispute, quantity being disputed, the billing and usage date/time dimension. Other attributes associated to the dispute may be included as required by a contract between the provider and the client (e.g., the dispute submitter, a dispute tracking ID, etc.). The dispute itself is represented may be represented as a separate state in the finite state model associated to the RU record. This detail along with the original RU attributes may be stored in a database table (e.g., in RU record repository 830 of FIG. 8) and can be used by reporting tools (e.g., billing and reporting module 870 of FIG. 8) to show the dispute history and its associated data attributes. It should be noted that because each RU record may be stored over both the usage and billing dimension the same dispute history may be created albeit without any optional attributes solely associated to the dispute database table by considering the current and historical resource unit records in the billing management system. Because each record is stored with its usage and billing dimension, the history of the record can be derived based on the first occurrence of an RU (e.g., in the either the usage or the billing time/date dimension) and by following the date/time line forward to construct each state change until the current date/time. This enables reporting and transaction tracking history of RU records.

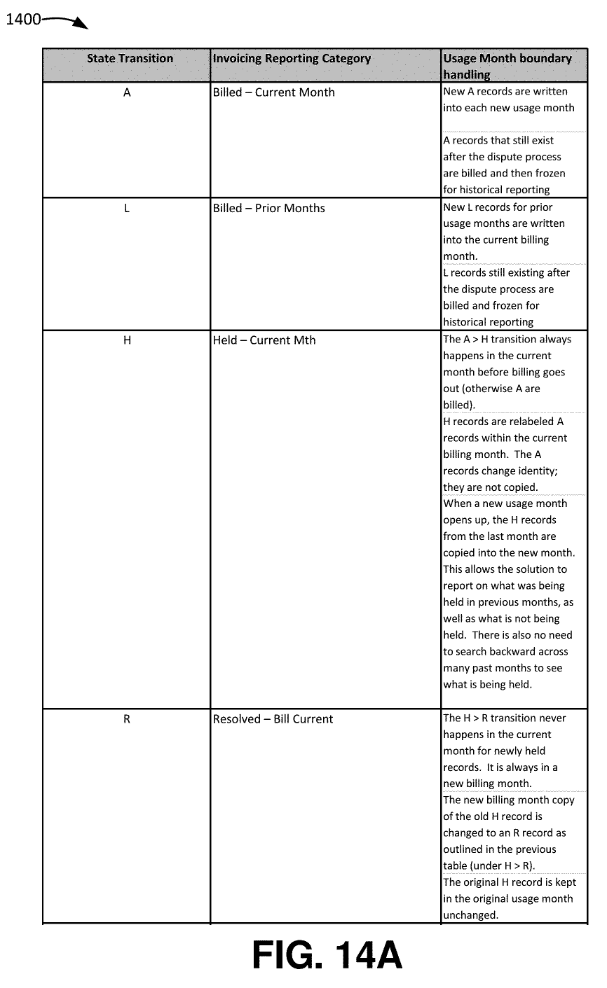

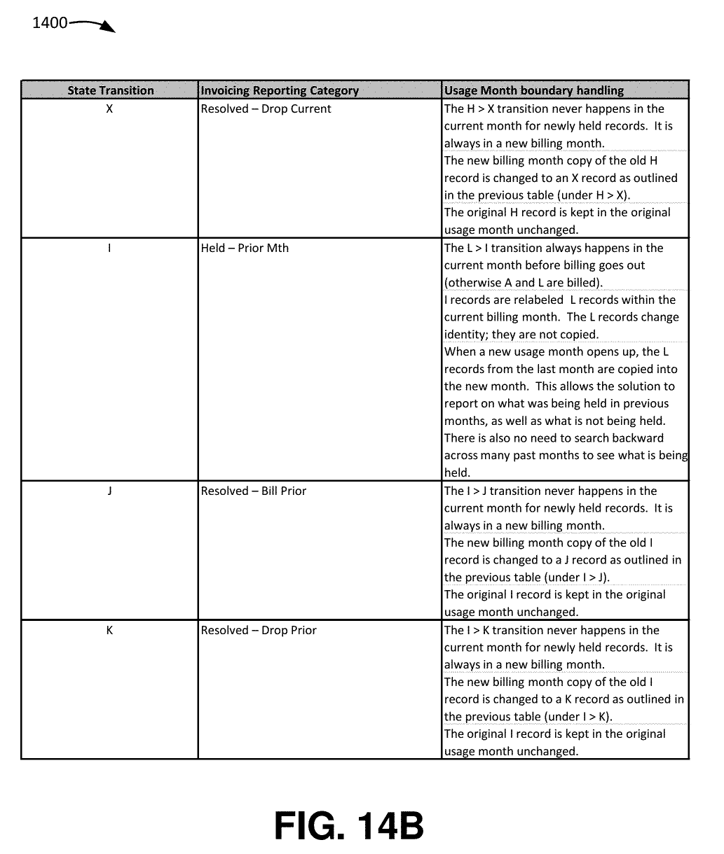

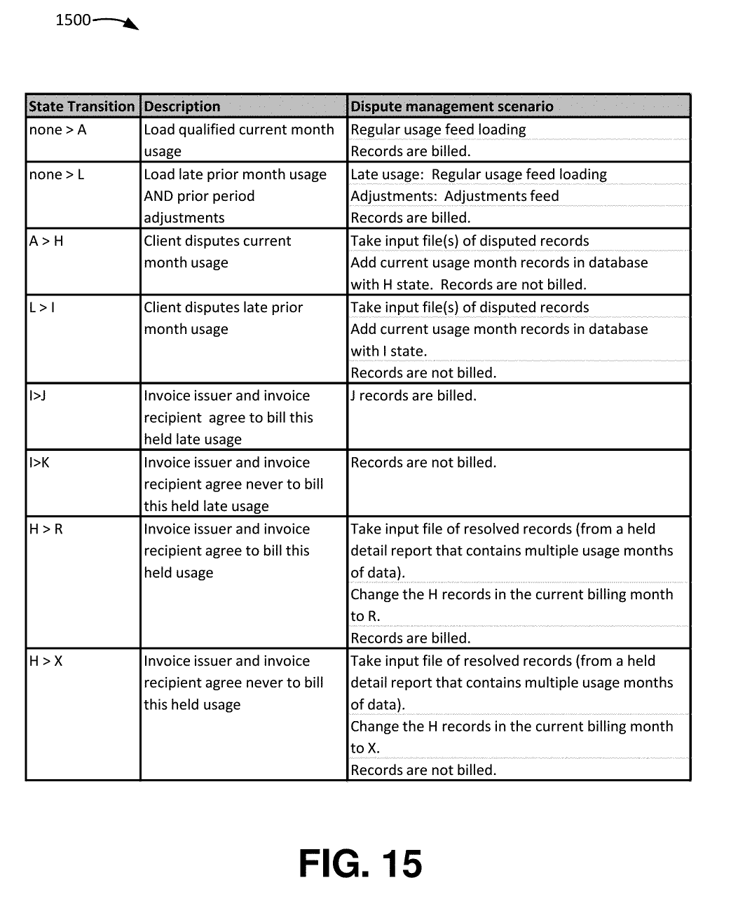

As described above with respect to the billing and reporting module 870 of FIG. 8, reporting and transaction tracking history of RU records may be obtained and viewed. For example, tables 1400, 1500, 1600, and 1700 in FIGS. 14A, 14B, 15, 16A, 16B, and 17, respectively, identify both how a client and/or provider would view the data as well as its association to the usage and billing dimension.

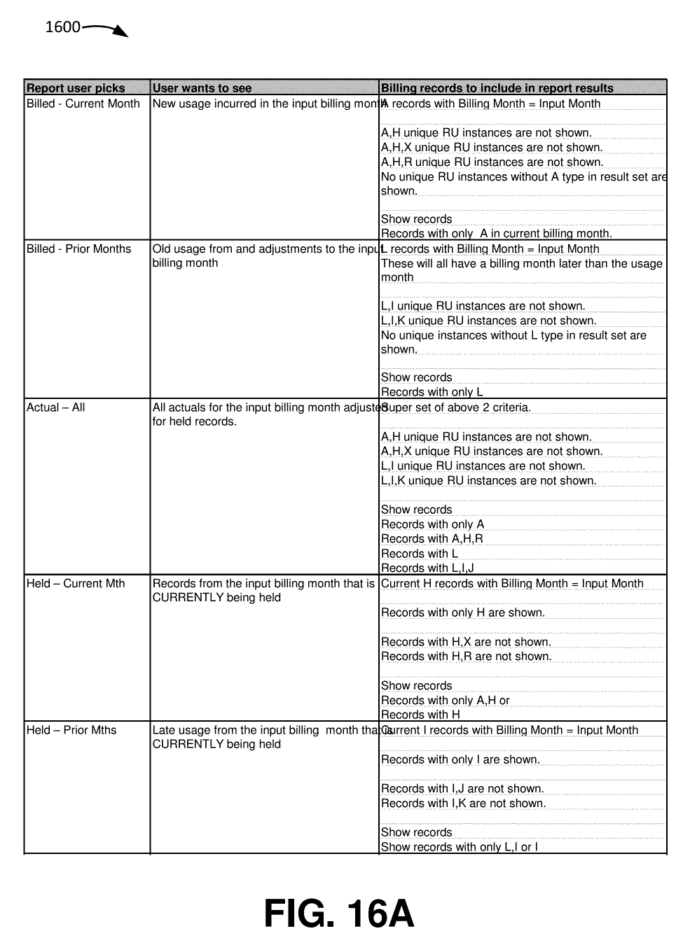

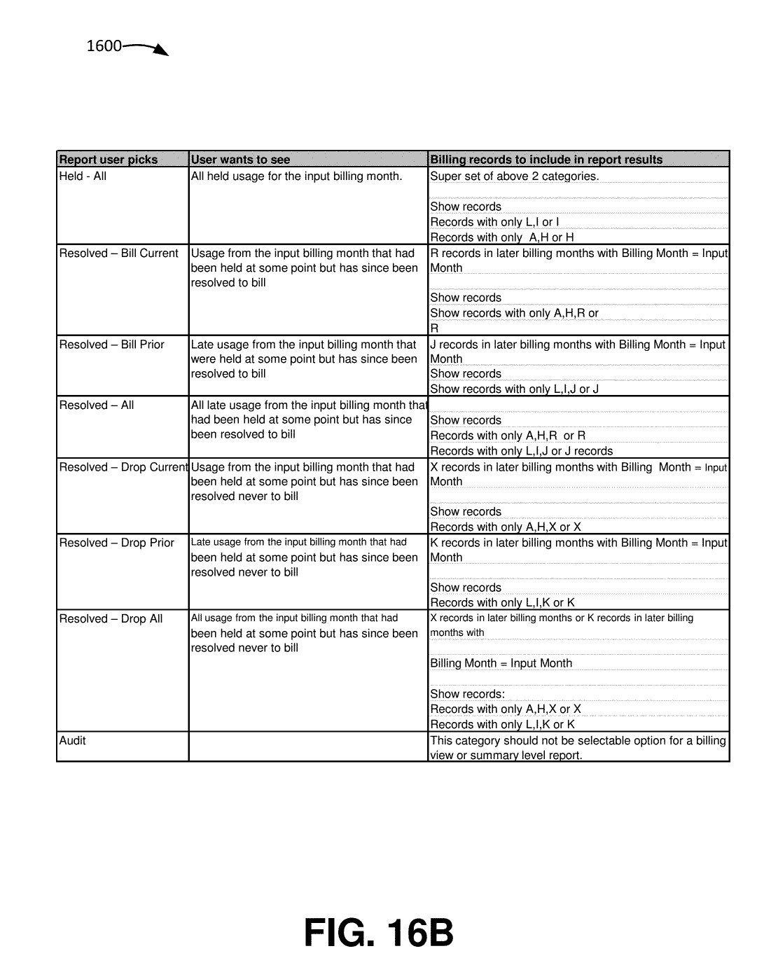

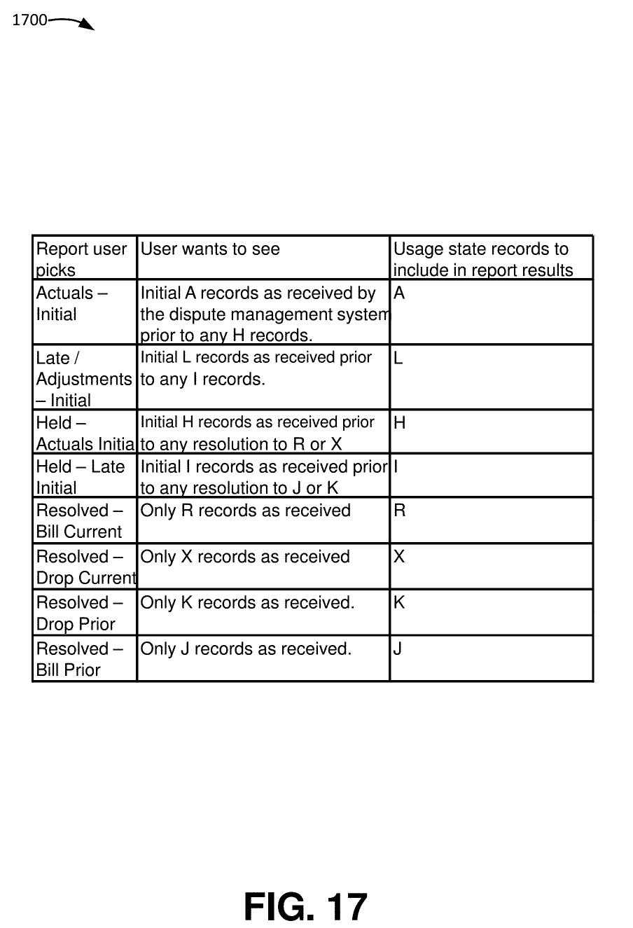

Because each RU is tracked at both a state and a usage and billing dimension, the client and/or provider may be able to view net quantity and charge against a given billing period and/or the accrual of quantity or charge(s) against a given usage period (e.g., as shown by table 1600 of FIG. 16. In embodiments, the same view can be applied against the usage dimension to identify patterns in the RUs originating from a respective usage period (e.g., as represented by table 1700 of FIG. 17). This enables the reporting solution to have enough data attributes to show quantity and charge trend over both usage and billing dimensions. An RU line item may be associated to every usage and billing date/time dimension for which it is applicable. Starting from the latest occurrence of an A or L state for a given resource unit state transitions can be reconstructed until a current point in time. Each invoice period may have one or more associated state transitions that obey the allowed state transitions defined for its state model.

In embodiments, reports may show the changes in state, as well as any associated attributes such as quantity or charge. In this way, a reporting solution may be implemented for the provider billing system 215 to show trends in both quantity and charge. By the same token, the transaction history may be made available (e.g., to a client and provider) since every state transition since the RU was introduced into the system is stored. This may be useful for forensic and/or more detailed examination of an invoice dispute, in particular when a partial quantity is disputed versus a full quantity for an RU.

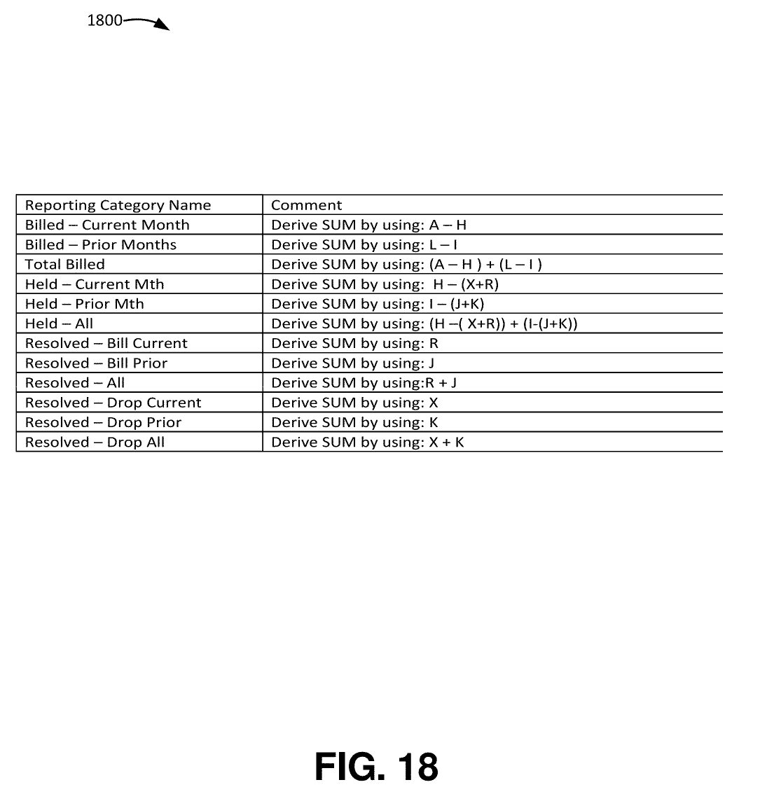

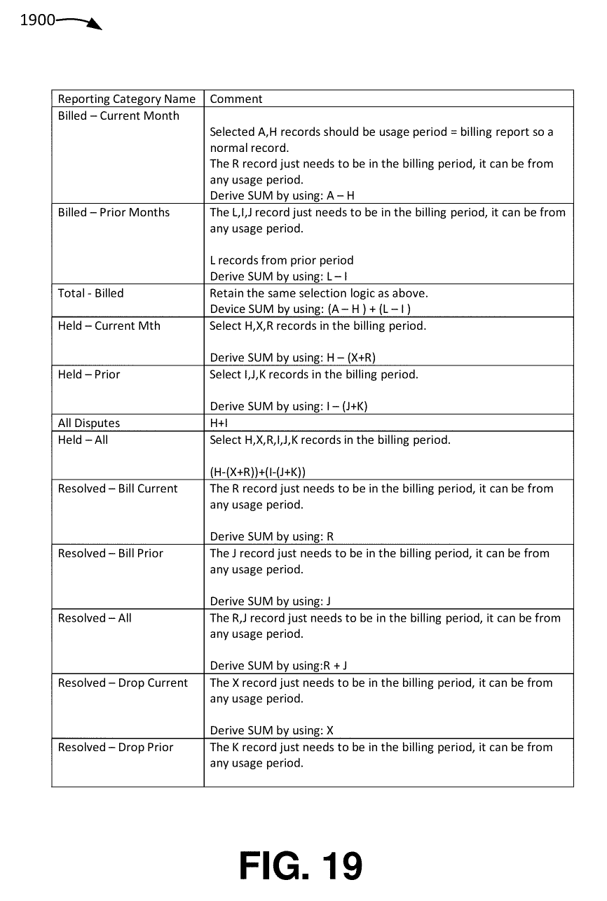

Since each resource unit is exists in 1 of 2 possible finite state models, the calculations required for any counting that is needed for billing may be simplified. For example, calculations for counting may be simplified in accordance with the counting formulas shown in tables 1800 and 1900 of FIGS. 18 and 19, respectively. The counting logic shown in tables 1800 and 1900 may be used to support any follow on financial calculations (e.g., variance calculations). In embodiments, the formulas shown in tables 1800 and 1900 may be used by way of storing (e.g., by the provider billing system 215) each billing and usage date time and a summary count of all applicable resource units in a given state. For example, given an RU that is measuring resource usage associated with Widget A, and further given that 10 Widget A's are reported for a given date/time period, that data may be stored along with all the other counts associated to Widget A for a given date/time period. By storing these data elements along with the basic RU information the counts into categories which are meaningful for billing and dispute management purposes may be easily summarized.

As an example, by considering all the records that are in a H or I state for a given date/time in the billing dimension, the potential financial shortfall which is associated to revenue not billed for a given period can be identified. Conversely, considering the counts related to R and J state records, additional disputed charges which were brought into a given invoice period may be identified. In embodiments, the usage and/or the charges related to these counts can be reported by applying the RU's contracted price for a summarized P×Q calculation in the reports.

In embodiments, a service provider, such as a Solution Integrator, could offer to perform the processes described herein. In this case, the service provider can create, maintain, deploy, support, etc., the computer infrastructure that performs the process steps of the invention for one or more clients. These clients may be, for example, any business that uses technology. In return, the service provider can receive payment from the client(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computing device, a resource unit (RU) record associated with a metered resource provided by a service provider to a client;
storing, by the computing device, the RU record;
tracking, by the computing device, a status of the RU record and updating the status based on receiving dispute resolution information regarding the RU record;
adding, by the computing device, the RU record to a final invoice when the status of the RU record indicates that the RU was not disputed or when the status of the RU record indicates that the RU was disputed and valid;
deleting, by the computing device, the RU record from a billing dimension to prevent the RU record from being added to the final invoice when the status of the RU record indicates that the RU record was disputed and invalid;
retaining, by the computing device, the RU record in the billing dimension when the status of the RU record indicates that the RU record is disputed and unsettled; and
providing, by the computing device, the final invoice to a client billing system.

2. The method of claim 1, wherein the adding, the deleting, and the retaining occurs at the end of a billing deadline.

3. The method of claim 1, further comprising determining that the RU record is qualified for being charged to the client based on at least one selected from a group consisting of:
business rules; and
terms in an agreement between the client and the service provider
wherein the tracking the RU record is based on determining that the RU record is qualified for being charged to the client.

4. The method of claim 1, further comprising providing a preliminary invoice report to the client billing system identifying the RU record based on storing the RU record, wherein the tracking is based on providing the preliminary invoice report.

5. The method of claim 4, further comprising receiving an indication from the client billing system that the RU record is under dispute based on providing the preliminary invoice report, wherein the tracking includes receiving the indication that the RU record is under dispute.

6. The method of claim 1, further comprising:
reviewing the status of the RU record at the end of a subsequent billing deadline when the RU record is retained; and
adding, deleting, or retaining the RU record based on the status of the RU record at the end of the subsequent billing cycle.

7. The method of claim 1, further comprising generating a report identifying a transition between states of the RU record.

8. The method of claim 1, wherein the storing the RU record includes storing attributes of the RU record.

9. The method of claim 1, further comprising generating a report identifying a condition under which the RU was disputed and updating qualification rules based on the identified condition.

10. The method of claim 1, wherein a service provider at least one of creates, maintains, deploys and supports the computing device.

11. The method of claim 1, wherein the receiving the RU record, the storing the RU record, the tracking the status of the RU record, the adding the RU record to the final invoice, the deleting the RU record from the billing dimension, the retaining the RU record in the billing dimension, and the providing the final invoice are provided by a service provider on a subscription, advertising, and/or fee basis.

12. The method of claim 1, wherein the computing device includes software provided as a service in a cloud environment.

13. The method of claim 1, further comprising deploying a system for tracking the dispute status of RU records, comprising providing a computer infrastructure operable to perform the receiving the RU record, the storing the RU record, the tracking the status of the RU record, the adding the RU record to the final invoice, the deleting the RU record from the billing dimension, the retaining the RU record in the billing dimension, and the providing the final invoice.

14. A computer program product for tracking disputes for metered resource units (RUs) the computer program product comprising a computer readable storage medium having program instructions embodied therewith, the program instructions executable by a computing device to cause the computing device to:
track the status of a plurality of RU records stored in a provider's billing system, the plurality RU records each being associated with a metered resource provided by the provider to a client;
analyze, at the end of a billing deadline, the plurality of RU records;
determine a status of each of the plurality of RU records based on the analyzing;
add a first subset of the plurality of RU records with an undisputed or settled valid status to a final invoice;
remove a second subset of the plurality of RU records with settled invalid statuses from a billing dimension;
maintain a third subset of the plurality of RU records having unsettled disputed statuses in the billing dimension; and
provide the final invoice to a client billing system.

15. The computer program product of claim 14, wherein the program instructions further cause the computing device to qualify each of the plurality of RU records to be charged to the client based on at least one selected from a group consisting of:
business rules; and
terms in an agreement between the client and the service provider
wherein the tracking the plurality of RU records includes the tracking the qualified RU records and preventing non-qualified RU records from appearing on the final invoice.

16. The computer program product of claim 14, wherein the program instructions further cause the computing device to provide a preliminary invoice report to the client billing system identifying the plurality of RU records, wherein the tracking is based on providing the preliminary invoice report.

17. The computer program product of claim 16, wherein the program instructions further cause the computing device to receiving information identifying RU records under dispute based on providing the preliminary invoice report, wherein the tracking includes receiving the information identifying the RU records under dispute.

18. The computer program product of claim 14, wherein the program instructions further cause the computing device to generate a report identifying a transition between states of each of the plurality of RU records.

19. A system comprising:
a CPU, a computer readable memory and a computer readable storage medium associated with a computing device;
program instructions to receive a resource unit (RU) record associated with a metered resource provided by a service provider to a client;
program instructions to store the RU record;
program instructions to provide a preliminary invoice report identifying the RU record to a client billing system;
program instructions to receive an indication that the RU record is under dispute based on providing the preliminary invoice report;
program instructions to store a status code within the RU record indicating that the RU record is under dispute;
program instructions to prevent the RU record from appearing on a final invoice associated with a first billing period in which the preliminary invoice report was provided;
program instructions to receive an indication, in a second billing period, that the RU record has been resolved and agreed to be paid by the client;
program instructions to add the RU record to a final invoice associated with the second billing period based on receiving the indication that the RU record has been resolved,
wherein the program instructions are stored on the computer readable storage medium for execution by the CPU via the computer readable memory.

20. The system of claim 19, further comprising program instructions to determine that the RU record is qualified for being charged to the client based on at least one selected from a group consisting of:
business rules; and
terms in an agreement between the client and the service provider,
wherein the providing the preliminary invoice report identifying the RU record is based on determining that the RU record is qualified for being charged to the client.
